(19) United States
(12) Patent Application Publication
(10) Pub. No.: US 2015/0306865 A1
(43) Pub. Date: Oct. 29, 2015

(54) PRINT-MARK TRANSFER SYSTEM FOR ROLL-SHAPED TRANSFER FILM

(71) Applicant: OZAKI SCREEN Co., Ltd., Kagawa (JP)

(72) Inventor: Masahiro Ozaki, Sakaide-shi (JP)

(21) Appl. No.: 14/647,941

(22) PCT Filed: Nov. 20, 2013
(86) PCT No.: PCT/JP2013/081325

§ 371 Date: May 28, 2015

(30) Foreign Application Priority Data
Nov. 30, 2012 (JP) 2012-263171

(51) Int. Cl. B41F 3/56

(52) U.S. Cl. CPC B41F 3/56

(57) ABSTRACT

A print-mark transfer system for roll-shaped transfer film is provided and uses a continuous-transfer machine that has: a pair of guide rollers that feed a roll-shaped transfer film in the horizontal direction; a press part disposed between the pair of guide rollers and from which a pressing surface protrudes downward toward the transfer film and an object to which a mark is to be transferred; a transfer platform on which the object receiving a mark is placed and that faces the pressing surface of the press part and receives pressure from the press part; and a positional sensor that detects a positioning mark provided between adjacent print marks. The present print-mark transfer system uses the continuous-transfer machine to continuously transfer print marks onto objects that are sequentially placed on the transfer platform and placed at the position where the roll-shaped transfer-film print marks are sequentially fed.

### TECHNICAL FIELD

The present invention relates to a print-mark transfer system for roll-shaped transfer film (hereinafter “present print-mark transfer system” when referring to this invention), wherein said system multiple print marks are formed on a plastic base film that is wound into a roll in such a manner that the print marks, which are arranged at equal intervals on the film, can be of any shape and be of various colors, and wherein said system the print marks are transferred to objects of various types, such as a fabric or leather, that are placed under the film one after another, so that the system allows the print marks to be continuously transferred to the objects, thus increasing the productivity of the print-mark transfer process.

### BACKGROUND ART

Generally, a conventional mark transfer film MF′ (MF′ stands for MFa′, MFb′, MFc′, etc.) is produced such that a plastic base film F′ is cut into strips, for example, with each strip having a size of 30 cm×40 cm, with a print mark M′ (M′ stands for Ma′, Mb′, Me′, etc.) printed on each strip of film so as to adhere to the film. As shown in FIG. 13, the transfer of a print mark M′ to a fabric is completed via the following steps: (1) setting a fabric K′ on a transfer platform T′; (2) setting a mark by which a strip of transfer film MF′ is set so that a print mark M′ is positioned so as to be opposed to a predetermined position on the fabric K′ that was set in the preceding step; (3) pressing the transfer film MF′ against the fabric K′ by using a press part Td′ of a transfer platform T′; and (4) removing the plastic base film F′ from the printed mark M′ so as to leave the print mark M′ on the fabric K′. (See, for example, Patent Document 1.)

### PRIOR ART DOCUMENT

### Patent Document

### [Patent Document 1] JP-A-2012-30823

### SUMMARY OF THE INVENTION

### Problems to be Solved by the Invention

However, the conventional transfer film MF′ described in Patent Document 1 et al. requires that (1) the plastic base film F′ be cut into strips so as to adhere a print mark M′ on each strip, and (2) each strip of the transfer film MF′ be placed, by using a pattern paper, laser pointer, or the like, on an object, such as a fabric K′, to which a mark is to be transferred, at the position where the mark of the strip is to be adhered to the object. Therefore, the conventional technique needs a high-level positioning technology that uses a position sensor in order to achieve accurate positioning of the mark to be adhered to the object, thus resulting in an inefficient manufacturing process due to difficulty in automating the process.

The present invention, which is intended to overcome the above-described problems, provides a print-mark transfer system for roll-shaped transfer film, in which system multiple print marks are continuously formed on a plastic base film that is wound into a roll in such a manner that the print marks can be of any shape and of various colors, and can be transferred to objects of various types, including fibers, leather, and so on, that are placed under the film one after another so that the system allows the print marks to be continuously transferred to the objects, thus simplifying and automating the print-mark transfer process and thereby increasing the productivity of the print-mark transfer process.

### Means of Solving the Problems

The present print-mark transfer system for roll-shaped transfer film is a system wherein multiple print marks are formed on a plastic base film that is wound into a roll in such a manner that the print marks can be of any shape and of various colors, and wherein the print marks can be transferred to various types of objects—made of fabric, leather, and so on—that are sequentially placed under the film one after another, so that the system allows the print marks to be continuously transferred to the objects, with the system using a continuous-transfer machine, comprising:
a first guide roller and a second guide roller that guide a roll-shaped transfer film, the film being pulled out and wound back by using a pullout means and a wind-back means, respectively, and being horizontally laid over the two guide rollers;
a press part, as a pressing and heating means, arranged between the first guide roller and the second guide roller so as to freely move vertically, to provide pressure from above onto, and to apply heat to, the roll-shaped transfer film and an object to which a mark is to be transferred, and from which there protrudes downward a pressing surface that covers the contour of the print mark;
a transfer platform on which the object to which a mark is to be transferred is placed opposed to the pressing surface of the press part so as to receive the downward pressure; and
a position sensor that detects positioning marks arranged between neighboring print marks of the roll-shaped transfer film;
and wherein the continuous-transfer machine allows any one of the print marks of the roll-shaped transfer film to be continuously transferred to the objects to which a mark is to be transferred, each of which objects is continuously placed on the transfer platform in such a manner that each object is positioned so as to be aligned with each print mark.

The present print-mark transfer system for roll-shaped transfer film provides a process that includes:
a pattern-paper-preparing stage for preparing a pattern paper on which are drawn an outline reference plan view of an object to which a mark is to be transferred, said drawing depicting a planar figure of the object, and a print-mark outline reference drawing depicting the contour of the print mark;
a print-mark outline reference aperture opening stage for making an outline reference aperture in the pattern paper along the contour of the print-mark outline reference drawing;
a position-sensor-setting stage for setting the position sensor of the transfer machine so that the print mark of the roll-shaped transfer film is opposed to the pressing surface of the press part;
a stage for transferring a print mark to a groundwood paper, in which stage a groundwood paper is placed on a first thick silicone-rubber plate that is arranged on the transfer platform, and the press part presses the print mark that is on the roll-shaped transfer film against the groundwood paper so as to transfer the print mark to the groundwood paper;
a pattern-paper-setting stage in which the pattern paper is placed on the groundwood paper to which the print mark has been transferred, so that the print mark outline reference aperture in the pattern paper is aligned with the transferred print mark;
a second thick silicone-rubber-plate-setting stage in which a second thick silicone-rubber plate is placed on the print mark outline reference aperture in the pattern paper;
a stage in which an object to which a mark is to be transferred is placed on the pattern paper on the transfer platform so that the object is aligned with the frame of the outline reference plan view of the object; and
a stage for transferring the print-mark to the object, in which stage one mark is pulled out of the roll-shaped transfer film by using a pullout means of the continuous-transfer machine so that the pulled-out mark is pressed against the object on the transfer platform by the press part, so as to transfer the mark to the object.

In the final stage of the present print-mark transfer system for transferring a print-mark to an object, after the press part has pressed the print mark of the roll-shaped transfer film against the transfer film, the press part moves up accompanying the plastic base film, automatically separating the film from the mark that has been transferred to the object.

The print mark of the present print-mark transfer system is formed by accumulating multiple layers one atop each other on the plastic base film, with the layers including:
a release layer, a protective layer, a design layer, a functional layer (covering layer, ink layer), a resin layer, and an adhesive layer, with the layers being formed such that:
the release layer is formed by uniform application of a parting agent that is made of organic material and that is removable after firing;
the protective layer is made of organic material and is removable after firing, so as to strengthen the design layer before the design layer is fired;
the design layer is formed by using printing techniques such as screen printing, offset printing, ink-jet printing, and color copying, so that designed marks can be of any shape;
the functional layer (covering layer, ink layer) is formed by screen printing using synthetic resins, including polyurethane resin, and an acrylic resin that is not damaged by washing, dry cleaning, friction, or elongation;
the resin layer is formed by screen printing using the same organic material as that of the protective layer, so as to increase the adhesion between the functional layer (covering layer, ink layer) and an adhesive layer, and
the adhesive layer, which is adhered to the object to which a mark is to be transferred, is formed by a process that includes the following steps: hot melt powder that has a particle size of about 50 μm-300 μm and that is formed of materials selected from high-polymer materials including urethane, nylon, polyester, and ethylene-vinyl acetate copolymer (EVA), with said material(s) being selected depending on the nature of the object to which a mark is to be transferred, is sprayed onto the just-formed and wet resin-layer, and is left to be dried so as to be fixed on the resin layer; the hot melt powder that remains without been fixed on the resin layer is removed; and the hot melt powder is heated so as to be fixed on the resin layer.

### Effects of the Invention

The present print-mark transfer system described above provides a process for continuously thermally transferring—to various objects to which a print mark is to be transferred—by using a continuous-transfer machine, multiple print marks formed on wound rolls of plastic base film, and for said print marks to be able to be of any shape and of various colors. These features of the present invention provide advantages over the prior art because a conventional mark-transfer system requires the cutting of transfer film into strips, using a pattern paper to set the position of each print mark relative to an object to which a mark is to be transferred, and the removal of the film from the mark to finish the transfer process, and these steps require manual operations that make the process troublesome. The present invention makes such a process automatic and thereby eliminates such troublesome manual operations. Thus, the present invention provides a print-mark transfer system that dramatically increases the production efficiency of print-mark transfers.

In particular, the present invention provides the following advantageous features: (1) the positions of the print mark, the pattern paper, and the object to which a mark is to be transferred (hereinafter “Object”) using the continuous-transfer machine of the present invention are easily set by use of the position sensor and the positioning mark of the roll-shaped transfer film; (2) that setting method also increases the precision of the position setting; (3) after the position is set, constantly placing the Object at the position corresponding to the frame of the plan view of the Object in the pattern paper allows the print marks to be consecutively thermally transferred to the same position of the Object; and (4) as a result, these features significantly increase the production efficiency of print-mark transfers.

Also, in the final stage of transferring a mark to an Object, after the press part has pressed the print mark of the roll-shaped transfer film, the press part moves up accompanying the plastic base film, which automatically separates the film from the mark that has been transferred to the Object. Thus, the removal of the plastic base film from the transferred mark, which conventionally is done manually, is done automatically by the present system.

Moreover, the adhesive layer for the print marks on the roll-shaped transfer film of the present invention is easily formed by spraying and fixing a hot melt powder, and therefore the adhesive layer formed that way is adaptable to any type of design layer (ink layer) and functional layer (covering layer, ink layer). Accordingly, this process of forming an adhesive layer reduces the manufacturing cost when producing either a small amount of roll-shaped transfer film carrying the print marks of different designs or a large amount of roll-shaped transfer film carrying the print marks of the same designs. Also, this way of layer forming easily adjusts the thickness of the adhesive layer by adapting the thickness of the layer according to the properties of the Object, such as cotton fabrics having rough surfaces.

### BRIEF DESCRIPTION OF THE DRAWINGS

FIG. 1 is a schematic diagram of the transfer process of the present print-mark transfer system according to an embodiment (Example 1) of the present invention.

FIG. 2 is a schematic sectional view showing the configuration of the layers of the print mark according to the embodiment shown in FIG. 1.

FIG. 3 is a schematic diagram of the print-mark manufacturing process shown in FIG. 2.

FIG. 4 is a flow diagram showing the manufacturing process of the roll-shaped transfer film according to one embodiment of the present invention.

FIG. 5 shows a photograph of the equipment for manufacturing the roll-shaped transfer film according to one embodiment of the present invention.

FIG. 6 shows photographs of the transfer process according to the embodiment shown in FIG. 1, and wherein FIG. 6(a) shows a pattern-paper-preparing stage in which a pattern paper is prepared by making an outline reference plan view that depicts a planar figure of an Object (fabric) and a print-mark outline reference drawing that depicts the contour of a print mark, and wherein FIG. 6(b) shows a reference-aperture-opening stage in which the reference aperture along the contour of the print mark is made in the pattern paper subsequent to the stage shown in FIG. 6(a).

FIG. 7 shows photographs of the transfer process subsequent to the stages in FIG. 6, and wherein FIG. 7(a) shows a roll-shaped-transfer-film setting stage subsequent to the stage shown in FIG. 6(b), and in which a first thick-silicone-rubber plate is placed on the transfer platform of a continuous-transfer machine according to the present invention's embodiment (Example 1) shown in FIG. 1, and wherein the roll-shaped transfer film is inserted in the continuous-transfer machine, and wherein FIG. 7(b) shows a print-mark-position-setting stage in which the position of the print mark is set so as to be opposed to the pressing part of the transfer machine.

FIG. 8 shows photographs of the transfer process subsequent to the stages in FIG. 7, and wherein FIG. 8(a) shows a position-sensor-setting stage subsequent to the stage shown in FIG. 7(b), and in which the position sensor of the continuous-transfer machine is set so that the position of the print mark matches the press-part pressing surface, and wherein FIG. 8(b) shows a print-mark-position-correction stage subsequent to the stage shown in FIG. 8(a), and in which the press part of the continuous-transfer machine presses a silicone rubber without pressing a print mark, when the print film is wound back by a print-mark length, so that the position of the print mark is automatically corrected when the print-mark transfer process is started.

FIG. 9 shows photographs of the transfer process subsequent to the stages in FIG. 8, and wherein FIG. 9(a) shows a pressing stage in which a groundwood paper is placed on the first thick-silicone-rubber plate arranged on the transfer platform, and the print mark of the roll-shaped transfer film is pressed against the groundwood paper P1 by the press part, which allows the print mark to be transferred to the groundwood paper P1, and wherein FIG. 9(b) shows a groundwood-paper transfer stage subsequent to the stage shown in FIG. 9(a), and in which the press part has been raised and the print mark has been transferred to the groundwood paper.

FIG. 10 shows photographs of the transfer process subsequent to the stages in FIG. 9, and wherein FIG. 10(a) shows a pattern-paper setting stage subsequent to the stage shown in FIG. 9(b), and in which a pattern paper is placed on the groundwood paper to which a print mark has been transferred, so that the position of the print-mark outline reference aperture is aligned with the print mark of the groundwood paper, and wherein FIG. 10(b) shows a second stage, in which a thick silicone-rubber plate is set subsequent to the stage shown in FIG. 10(a), and in which a second thick silicone-rubber plate is placed on the print mark of the groundwood paper so as to align with the print-mark outline reference aperture of the pattern paper.

FIG. 11 shows photographs of the transfer process subsequent to the stages in FIG. 10, and wherein FIG. 11(a) shows a stage wherein a thin silicone-rubber plate is set subsequent to the stage shown in FIG. 10(b), and in which the second thick silicone-rubber plate has been removed, and a thin silicone-rubber plate has been placed on the print mark of the groundwood paper P1 that is aligned with the print-mark outline reference aperture Pb1 of the pattern paper P, and wherein FIG. 11(b) shows a fabric-setting stage subsequent to the stage shown in FIG. 11(a), in which subsequent stage the fabric is placed on the pattern paper on the transfer platform so as to be aligned with the frame of an outline reference plan view for the fabric.

FIG. 12 shows a photograph of the transfer process subsequent to the stage shown in FIG. 11(b), and wherein the photograph shows a print-mark-transfer-to-fabric stage, in which a print mark has been transferred after the print mark of the continuous-transfer machine has been pressed against the fabric on the transfer platform by the press part.

FIG. 13 is a schematic diagram showing a conventional mark-transfer system.

### MODE FOR CARRYING OUT THE INVENTION

Aspects of the present print-mark transfer system will now be described in detail, referring to the attached drawings.

One embodiment of the present print-mark transfer system provides features such that multiple print marks M (M stands for Ma, Mb, Me, etc.) are formed on a plastic base film F, which is wound into a roll, in such a manner that the print marks can be of any shape and of various colors, so that the print marks are thermally consecutively transferred to various Objects K, including those made of fabric and leather.

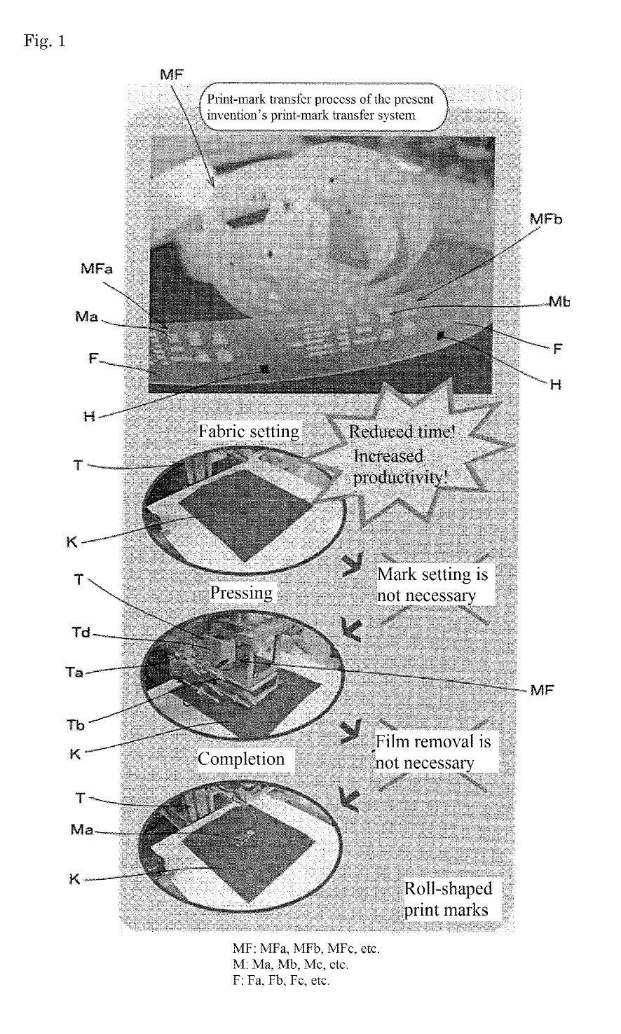

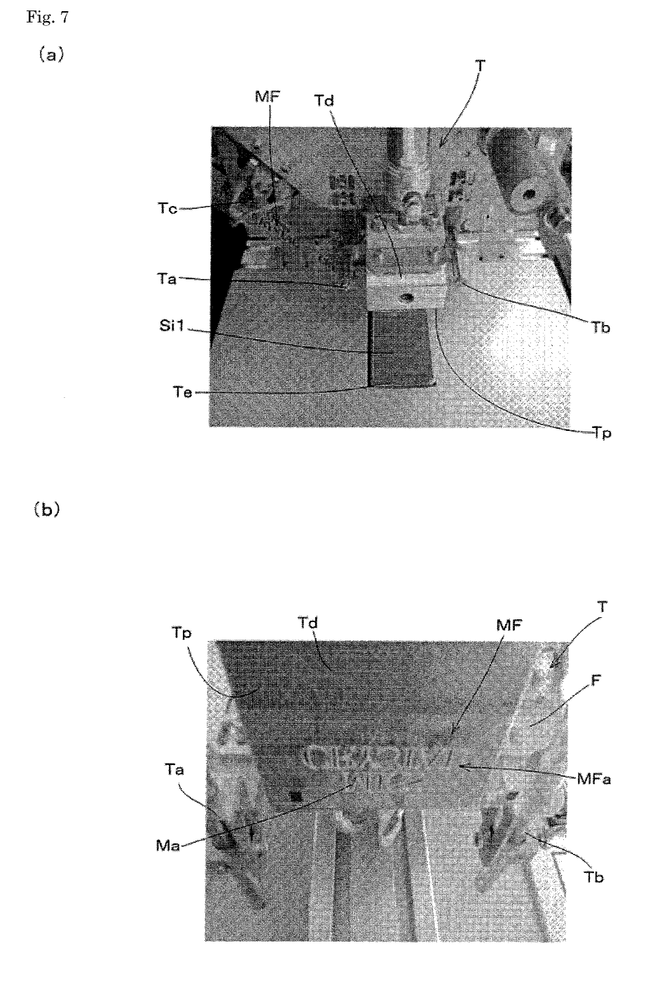

One embodiment of the present print-mark transfer system includes a continuous-transfer machine T. As is shown in FIGS. 7-12, and as described below, the transfer machine T includes the following parts: (1) a first guide roller Ta and a second guide roller Tb that guide a roll-shaped transfer film MF that can be pulled out and wound back by using a pullout means (not shown) and a wind-back means (not shown), respectively, with said transfer film MF horizontally laid over the two guide rollers, (2) a press part Td, which is a pressing and heating means that is arranged between the first guide roller Ta and the second guide roller Tb so as to freely move vertically and to provide, to a roll-shaped transfer film MF and to an Object K, pressure from above and heat, and from which a pressing surface Tp that covers the contour of the print mark M protrudes downward, (3) a transfer platform Te on which the Object K is placed so as to be opposed to the pressing surface Tp of the press part Td, so as to receive pressure, and (4) a position sensor Tc, which detects positioning marks H (see FIG. 1) arranged between neighboring print marks Ma and Mb. Mb and Mc, etc. of the roll-shaped transfer film MF. This continuous-transfer machine T allows any one of the print marks Ma, Mb, Mc, etc. of the roll-shaped transfer film MF to be continuously transferred to the Objects K, each of which is placed on the transfer platform Te one after another in such a manner that each Object is positioned so as to be aligned with the position of each print mark M (usually to that of the print mark Ma at the start of the transfer process).

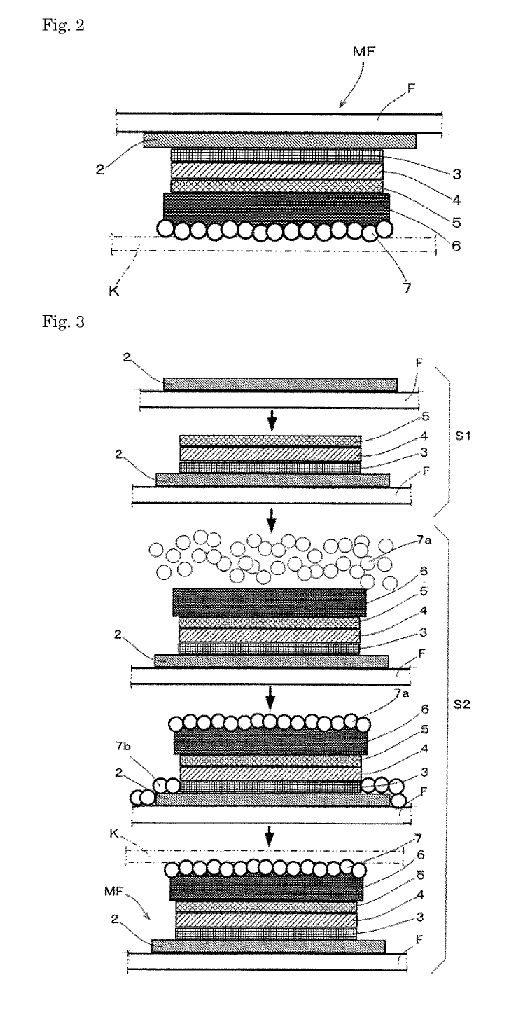

According to one embodiment of the present invention, the print marks M of the roll-shaped transfer film MF are formed as described below, but the details of the manufacturing process are not presented here because known thermal-transfer techniques are applicable to the process. As shown by the schematic sectional view in FIG. 2, multiple layers are formed on a plastic base film F made of polyethylene terephthalate (PET) film or the like. The layers are stacked, on top of each other and include: (1) a release layer 2 that is made of organic materials and that is removed after firing, (2) a protective layer 3 that is made of organic material and that is removable after firing, so as to strengthen the design layer 4 by imparting protective properties such as abrasion resistance and laundering fastness to the layer 4 before the layer 4 is fired, (3) a design layer (ink layer) 4 that is formed such that the designed marks can be of any shape. (4) a functional layer (covering layer, ink layer) 5 formed by screen printing using synthetic resins. (5) a resin layer 6 made of the same organic material as that of the protective layer, to increase the adhesion between the functional layer 5 and an adhesive layer 7, and (6) the adhesive layer 7, which is made by heating a hot melt powder 7a to be adhered to the Object K.

### Example 1

### A Method of Manufacturing Roll-Shaped Transfer Film

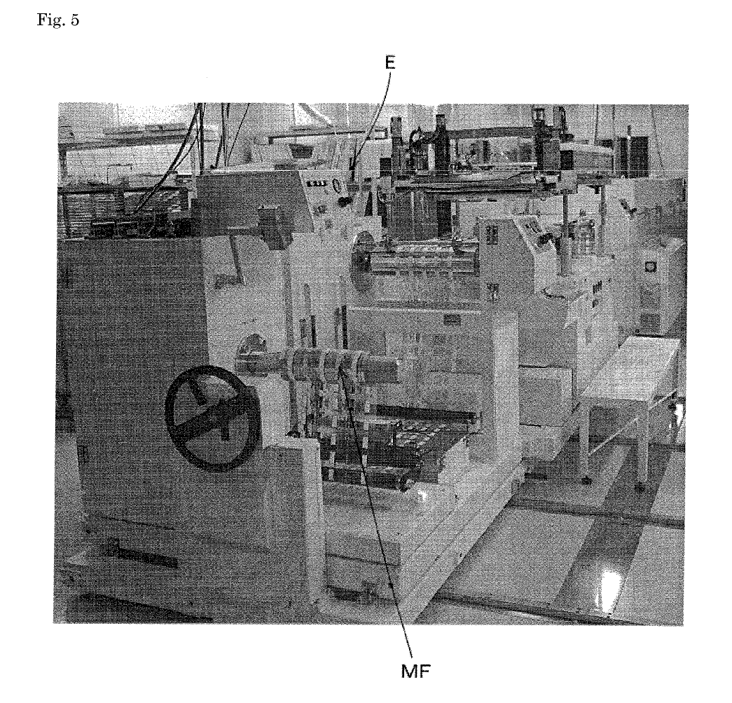

The process for manufacturing roll-shaped transfer film MF is not described in detail herein, because known thermal-transfer techniques are applicable to this process. According to one embodiment of the present invention, as is shown by the photograph of FIG. 5, the roll-shaped-transfer-film manufacturing equipment E includes an ink-jet printer, a plastic base film cassette-mechanism part, and a computer-control part to control those parts, and for which reference signs are not given.

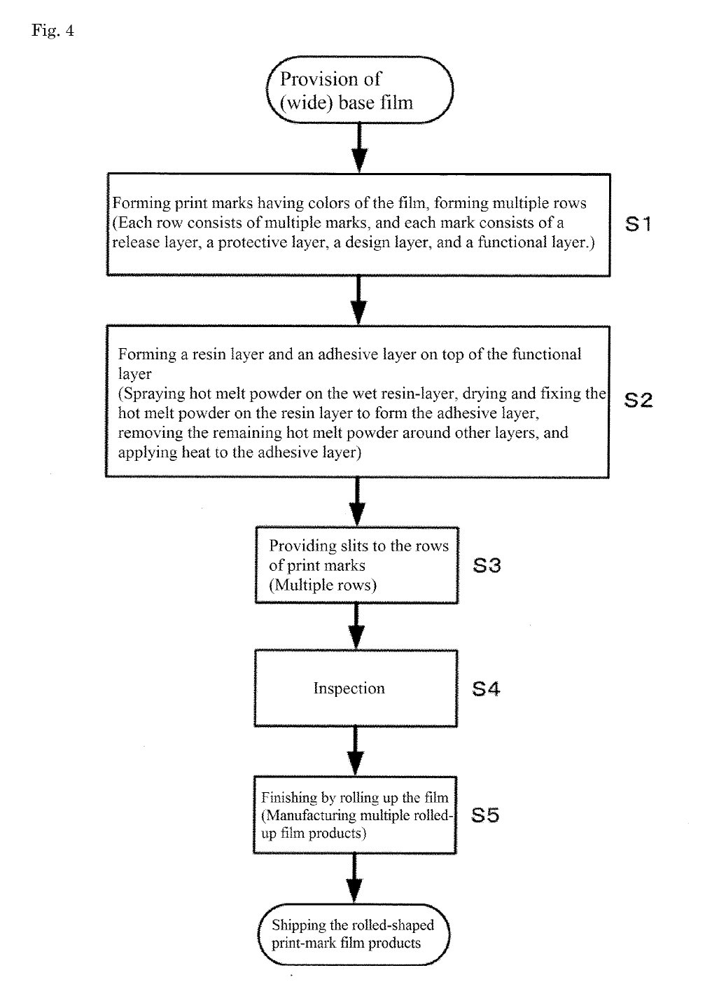

As is shown by schematic diagrams in FIGS. 2 and 3, and by the FIG. 4 flow diagram showing how the roll-shaped transfer film is manufactured, multiple layers that are to form print marks are formed on a wide, plastic base film F made of PET film or the like, with the layers arranged in multiple rows, such as, for example, in five rows, wherein the layers include (1) a release layer 2 formed by uniform application of a parting agent that is made of organic material and that is removable after firing, (2) a protective layer 3 that is made of organic material and that is removable after firing, to strengthen the design layer 4 by imparting protective properties such as abrasion resistance and laundering fastness to the layer 4 before the layer is fired, (3) a design layer (ink layer) 4 that is formed by using printing techniques, including screen printing, offset printing, ink-jet printing, and color copying, so that the designed marks can be of any shape, and (4) a functional layer (covering layer, ink layer) 5 that is formed by screen printing using synthetic resins, including aqueous polyurethane resin and acrylic resins, that will not be damaged by washing dry cleaning, friction, or elongation (print-mark color-printing stage S1).

The layers further include a resin layer 6 and an adhesive layer 7. The resin layer 6 is formed by screen printing using the same organic material as that of the protective layer, so as to increase the adhesion between the functional layer 5 and the adhesive layer 7. The adhesive layer 7, which is adhered to an Object K, is formed by the following process: (1) hot melt powder 7a that has a particle size of about 50 μm-300 μm and that is formed of high-polymer materials, including urethane, nylon, polyester, and ethylene-vinyl acetate copolymer (EVA), selected depending on the nature of the Object K, is sprayed on the just-formed and wet resin-layer 6, and is left to be dried so as to be fixed on the resin layer 6; (2) the hot melt powder 7b that has not been fixed on the resin layer 6 but still exists around the ink layers 4 and 5 is removed using a brush such as an airbrush or a rotary brush; and (3) the hot melt powder 7a is heated at 150° C. for 120 seconds so that the layer 7 is fixed on the layer 6 by firing (resin layer, adhesive-layer printing stage S2).

In forming the functional layer 5 (covering layer, ink layer), the number of times that screen printing is performed is determined by the required strength of the layer 5 and other relevant conditions.

In forming the adhesive layer 7, the type and particle size of the thermoplastic resin and the thickness of the layer are determined so as to maintain appropriate adhesive strength of the layer, depending on the nature of the Object K.

Accordingly, the roll-shaped transfer film is manufactured as follows: multiple print marks M (Ma, Mb, Me, etc.) of any shape and of various colors are (1) formed on a base film F by stacking the layers of the release layer 2, the protective layer 3, the design layer 4, the functional layer 5, the resin layer 6, and the adhesive layer 7, (2) arranged in multiple rows at equal intervals between the positioning marks H (see FIG. 1); each row is provided with slits in the longitudinal direction (slitting stage S3); the inspection stage S4 follows the slitting stage S3; and then the base film on which the layers have been formed are wound, for example, five times, into a roll, resulting in roll-shaped transfer film MF ready to be shipped.

### (Print-Mark Transfer Process)

The transfer process using the print-mark transfer system for roll-shaped transfer film of Example 1 will now be described, referring to FIG. 1 and FIGS. 6-12. Multiple print marks M on the roll-shaped transfer film MF are respectively transferred to fabrics K as Objects K, using the continuous-transfer machine T. Each print mark M in this Example is transferred to the fabrics K, which are Objects K, so as to form a brand name, size information, or a care-label symbol—each of any shape or any color on each fabric K.

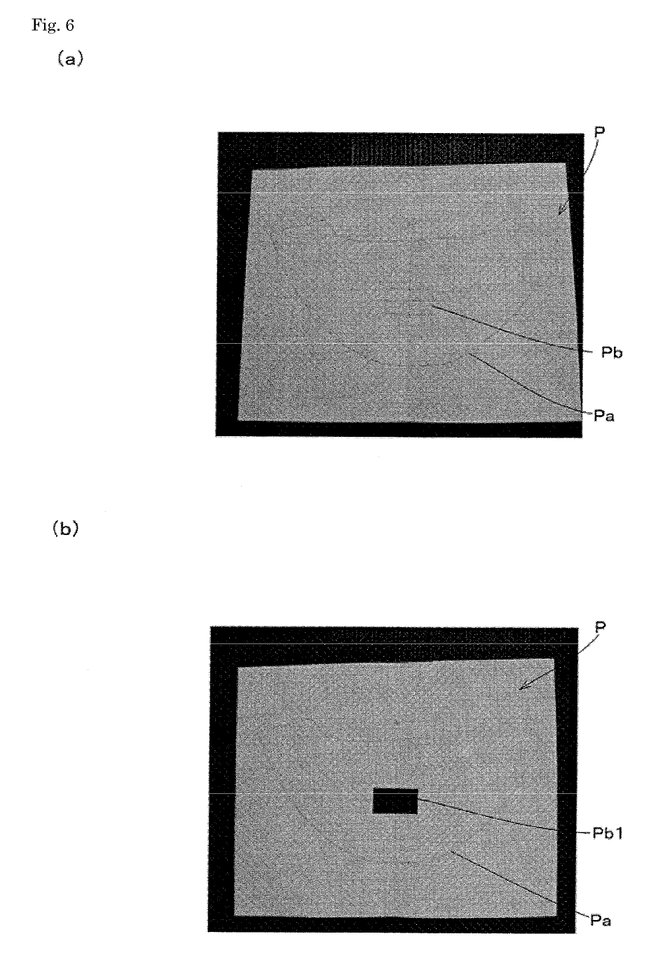

As is shown in FIG. 6(a), there is prepared a pattern paper P on which are drawn an outline reference plan view Pa that depicts the planar figure of the fabric K, which is the Object, and the print-mark outline reference drawing Pb that depicts the external form of the print mark M (pattern-paper-preparing stage).

Then, as is shown in FIG. 6(b), a print-mark outline reference aperture Pb1 is made in the pattern paper P, with the contour of that aperture being aligned with that of the print-mark outline reference drawing Pb (print-mark outline reference aperture opening stage).

Then, according to one embodiment of the present invention, the first thick silicone-rubber plate Si1 is placed on the transfer platform Te of the continuous-transfer machine T, and the roll-shaped transfer film MF is inserted in the continuous-transfer machine T (roll-shaped-transfer-film-setting stage), as is shown in FIG. 7(a).

Then, as is shown in FIG. 7(b), the position of the roll-shaped transfer film MF is set so that the position of the initial print mark Ma of the roll-shaped transfer film MF is aligned with the press-part pressing surface Tp of the continuous-transfer machine T (print-mark-position-setting stage).

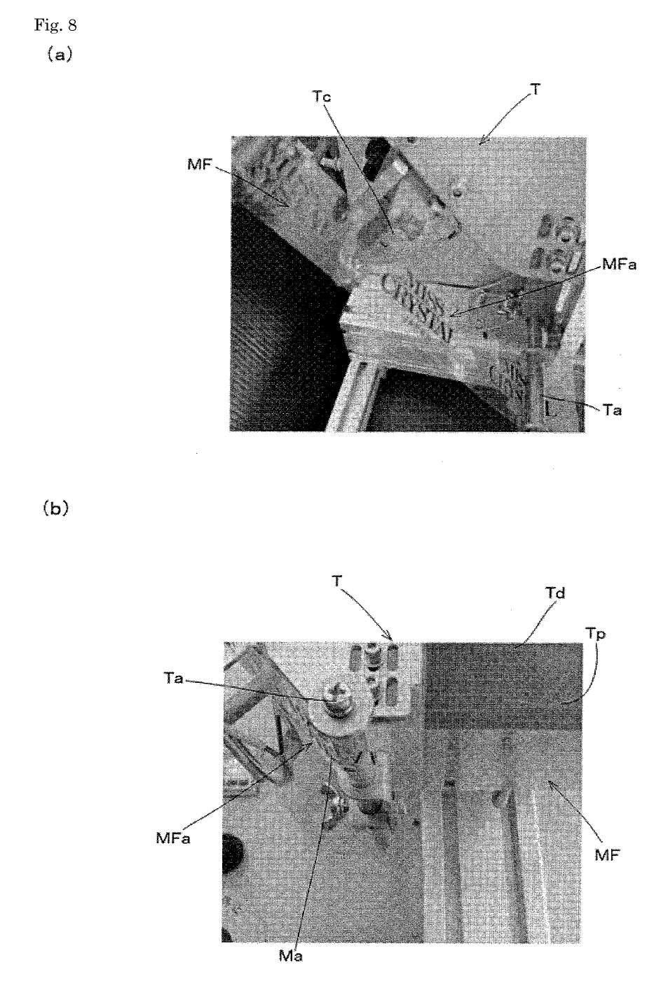

Then, as is shown in FIG. 8(a), when the roll-shaped transfer film MF is set to the print-mark-position-setting position, the position sensor Tc of the continuous-transfer machine T is set (position-sensor-setting stage).

Then, as is shown in FIG. 8(b), when the roll-shaped transfer film MF is wound back by the length of the initial print-mark Ma, the press part Td of the continuous-transfer machine T is lowered, so that the press part Td presses the first thick silicone-rubber plate Si1 without pressing the initial print mark Ma, so that the position of the print mark is automatically corrected when the print-mark transfer process is started (print-mark-position-correction stage).

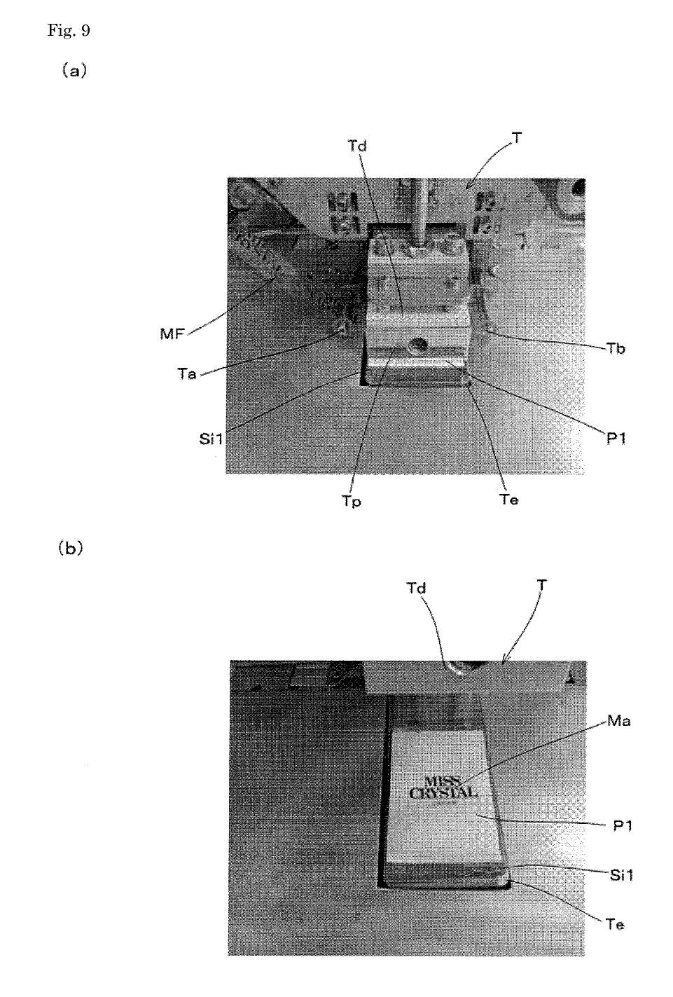

Then, as is shown in FIG. 9(a), a groundwood paper P is placed on a first thick silicone-rubber plate Si1 arranged on the transfer platform Te, and the print mark Ma of the roll-shaped transfer film MF is pressed against the groundwood paper P1 by the press part Td, which allows the print mark Ma to be transferred to the groundwood paper P1 (pressing stage).

Then, as is shown in FIG. 9(b), the press part Td of the continuous-transfer machine T is raised, and the print mark Ma is transferred to the groundwood paper P1 (stage of transferring print mark to groundwood paper).

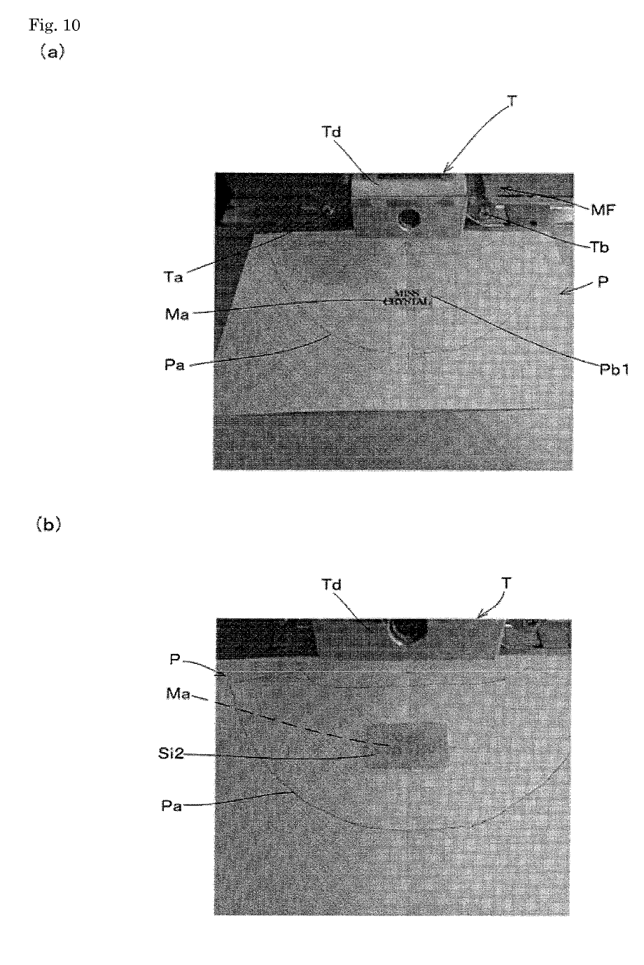

Then, as is shown in FIG. 10(a), a pattern paper P is placed on the groundwood paper P1 to which the print mark Ma has been transferred, so that the print-mark outline reference aperture Pb1 is aligned with the print mark Ma of the groundwood paper P1 (pattern-paper-setting stage).

Then, as is shown in FIG. 10(b), a second thick silicone-rubber plate Si2 is placed on the print mark Ma of the groundwood paper P1 so as to be aligned with the print-mark outline reference aperture Pb1 of the pattern paper P (stage of setting second thick silicone-rubber plate).

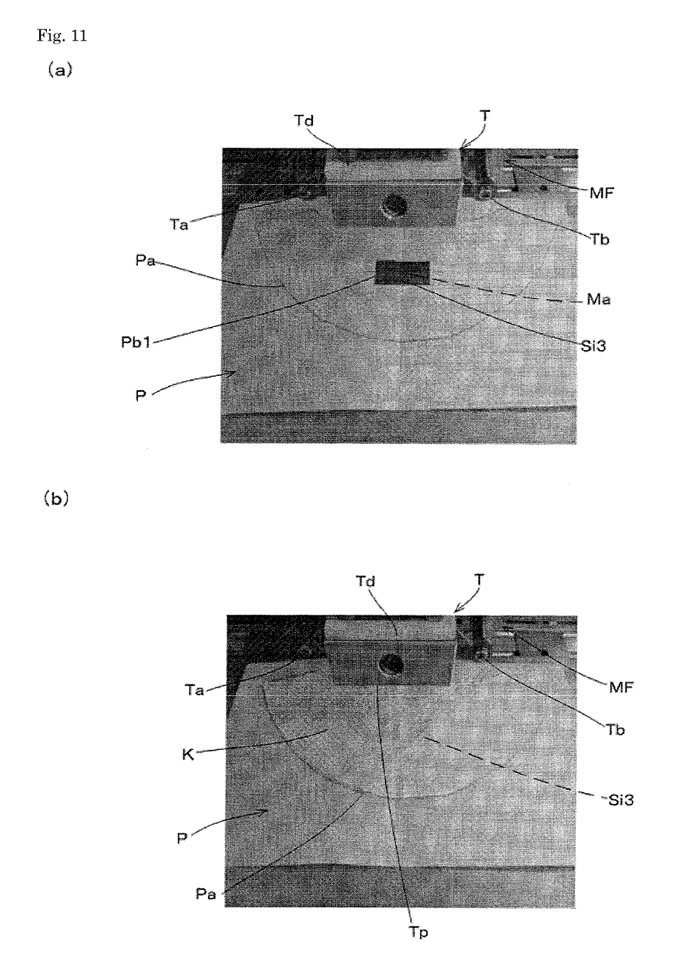

Then, as is shown in FIG. 11(a), the second thick silicone-rubber plate Si2 is removed, and a thin silicone-rubber plate Si3 is placed on the print mark Ma of the groundwood paper P1 so as to be aligned with the position of the print-mark outline reference aperture Pb1 of the pattern paper P (stage of setting thin silicone-rubber plate).

Each of the first thick silicone-rubber plate Si1, the second thick silicone-rubber plate Si2, and the thin silicone-rubber plate Si3 serves to prevent the generation of pressed marks and thermal damage due to pressing by the press part Td, which is a pressing and heating means, on parts other than the print mark M (namely, on the pattern paper P, the groundwood paper P1, and the fabric K). Each of the first thick silicone-rubber plate Si1, the second thick silicone-rubber plate Si2, and the thin silicone-rubber plate Si3 is also expected to prevent the lateral displacement of the pattern paper P, the groundwood paper P1, and the fabric K.

Then, as is shown in FIG. 11(b), the fabric K is placed on the pattern paper P on the transfer platform Te so as to correspond to the frame of an outline reference plan view for fabric Pa (fabric-setting stage).

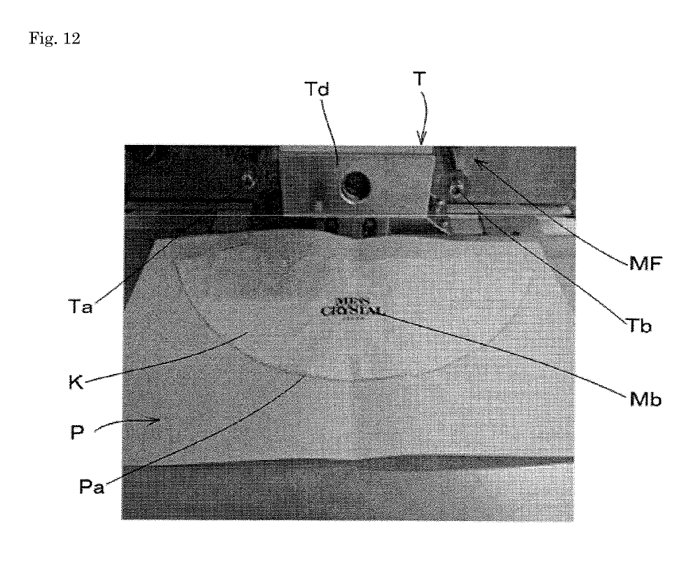

Then, as is shown in FIG. 12, the print mark Mb of the roll-shaped transfer film MF, which is formed next to the print mark Ma and is pulled out by a pullout means (not shown) of the continuous-transfer machine T, is pressed against the fabric K on the transfer platform Te by the press part Td, so that the print mark Mb is transferred to the fabric K (stage of transferring print mark to fabric).

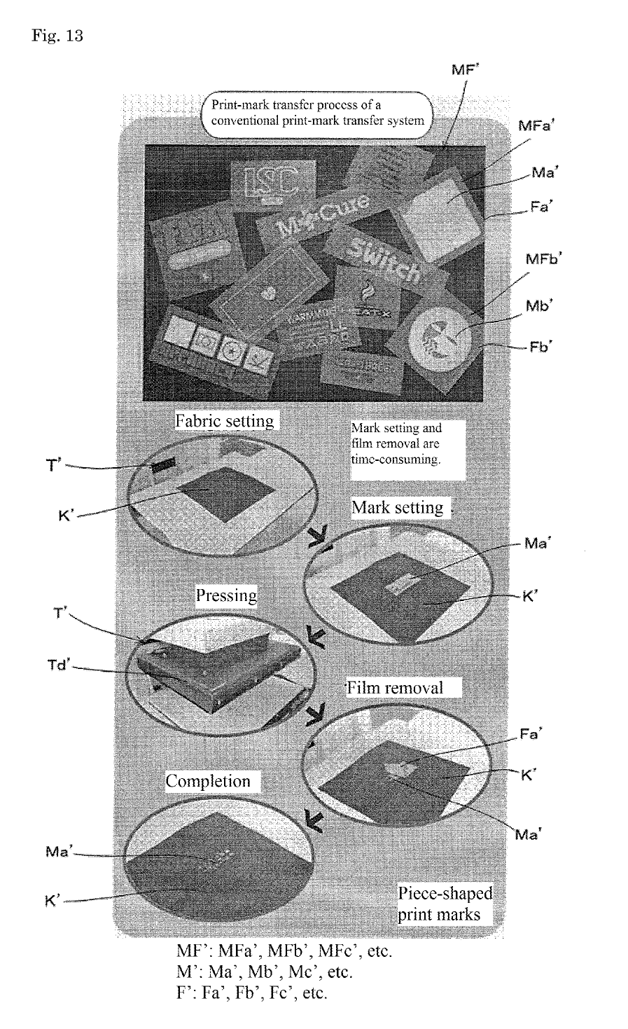

The above-described print-mark transfer system of the present invention provides a process, as is schematically shown in FIG. 1, for continuously thermally transferring multiple print marks M that are formed on a wound, roll-shaped plastic base film F and that can be of any shape and of various colors to various Objects K using a continuous-transfer machine T. These features of the present invention provide advantages over the prior art because a conventional mark-transfer system requires the steps of cutting a transfer film into strips, setting the position of each print mark relative to an Object by using a pattern paper, and removing the film from the mark to finish the transfer process, and these steps require manual operations making the process troublesome (see FIG. 13). The present invention makes such a process automatic, thereby eliminating such troublesome manual operations.

Moreover, the present invention provides the following advantageous features: by using the continuous-transfer machine T of the present invention, the positions of the print mark M, the pattern paper P, and the Object K are easily set by use of the position sensor Tc and the positioning mark H of the roll-shaped transfer film MF, which also increases the precision of the position settings; after the position settings have been made, constantly placing the Object K on the position being aligned with the frame of the outline reference plan view Pa of the Object K in the pattern paper P allows the print marks M to be consecutively thermally transferred to the same position of the Object K; accordingly, these features significantly increase the production efficiency of print-mark transfers.

In addition, the Object K in the print-mark transfer system of the present invention is not limited to the fabric in the above Example 1, but can include various objects, such as clothing items including aprons, headbands, towels, handkerchiefs, arm covers, happi coats, shirts, jackets, kimonos, cosplay clothes, and arm bands; textile-related goods including flags, noren shop curtains, table covers, tents, and banner stands; and bag products made of leather, vinyl, plastic, rubber, or paper.

### INDUSTRIAL APPLICABILITY

The print-mark transfer system of the present invention provides a process for using a continuous-transfer machine T to continuously thermally transfer to various Objects K multiple print marks M that can be of any shape and of various colors, and that are formed on a wound, roll-shaped plastic base film F, thus making the mark-transfer process automatic, thereby eliminating troublesome manual operations. Moreover, the present invention provides the following advantageous features: using the continuous-transfer machine T of the present invention makes it easy to set the positions of the print mark M, the pattern paper P, and the Object K by using the position sensor Tc and the positioning mark H of the roll-shaped transfer film MF, which also increases the precision of the position settings; after the positions have been set, constantly placing the Object K on the position being aligned with the frame of the outline reference plan view Pa of the pattern paper P allows the print marks M to be consecutively thermally transferred to the same position of each Object K; accordingly, these features significantly increase the efficiency of mark-transfer work. In addition, the Object K in the print-mark transfer system of the present invention may include various objects, such as: articles made of clothing, including aprons, headbands, towels, handkerchiefs, arm covers, happi coats, shirts, jackets, kimonos, cosplay clothes, and arm bands; textile-related goods, including flags, noren shop curtains, table covers, tents, and banner stands; and bag products made of leather, vinyl, plastic, rubber, or paper. Accordingly, the system of the present invention is applicable to industries that include, and businesses that handle, sporting goods, textile goods, and tarpaulin goods, as well as printing businesses.

### DESCRIPTIONS OF REFERENCE SIGNS

2: release layer
3: protective layer
4: design layer (ink layer)
5: functional layer (covering layer, ink layer)
6: resin layer
7: adhesive layer
7a: hot melt powder (fixed)
7b: hot melt powder (unfixed)
E: roll-shaped transfer-film manufacturing equipment
F, F′: plastic base film
H: positioning mark
J: base-film abutting tool
K: object to which a mark is to be transferred (fabric)
M, Ma, Mb, Mc, . . . , M′, Ma′, Mb′, Mc′: print mark
MF: roll-shaped transfer film
MF′, MFa′, MFb′, MFc′: transfer film
P: pattern paper
Pa: outline reference plan view of the object to which a mark is to be transferred (fabric)
Pb: print-mark outline reference drawing
Pb1: print-mark outline reference aperture
P1: groundwood paper
Si1: first thick silicone-rubber plate
Si2: second thick silicone-rubber plate
Si3: thin silicone-rubber plate
T: continuous-transfer machine
Ta: first guide roller
Tb: second guide roller
Tc: position sensor
Td: press part
Te: transfer platform
Tp: pressing surface

1. A print-mark transfer system for roll-shaped transfer film, wherein multiple print marks are formed on a plastic base film that is wound into a roll in such a manner that the print marks can be of any shape and of various colors, and wherein the print marks can be transferred to various types of objects—made of fabric, leather, and so on—that are sequentially placed under the film one after another, so that the system allows the print marks to be continuously transferred to the objects, with the system using a continuous-transfer machine, comprising:
a first guide roller and a second guide roller that guide a roll-shaped transfer film, the film being pulled out and wound back by using a pullout means and a wind-back means, respectively, and being horizontally laid over the two guide rollers;
a press part, as a pressing and heating means, arranged between the first guide roller and the second guide roller so as to freely move vertically, to provide pressure from above onto, and to apply heat to, the roll-shaped transfer film and an object to which a mark is to be transferred, and from which there protrudes downward a pressing surface that covers the contour of the print mark;
a transfer platform on which the object to which a mark is to be transferred is placed opposed to the pressing surface of the press part so as to receive the downward pressure; and
a position sensor that detects positioning marks arranged between neighboring print marks of the roll-shaped transfer film;
and wherein the continuous-transfer machine allows any one of the print marks of the roll-shaped transfer film to be continuously transferred to the objects to which a mark is to be transferred, each of which objects is continuously placed on the transfer platform in such a manner that each object is positioned so as to be aligned with each print mark.

2. The print-mark transfer system for roll-shaped transfer film according to claim 1, and wherein the system provides a process comprising:
a pattern-paper-preparing stage for preparing a pattern paper on which are drawn an outline reference plan view of an object to which a mark is to be transferred, said drawing depicting a planar figure of the object, and a print-mark outline reference drawing depicting the contour of the print mark;
a print-mark outline reference aperture opening stage for making an outline reference aperture in the pattern paper along the contour of the print-mark outline reference drawing;
a position-sensor-setting stage for setting the position sensor of the transfer machine so that the print mark of the roll-shaped transfer film is opposed to the pressing surface of the press part;
a stage for transferring a print mark to a groundwood paper, in which stage a groundwood paper is placed on a first thick silicone-rubber plate that is arranged on the transfer platform, and the press part presses the print mark that is on the roll-shaped transfer film against the groundwood paper so as to transfer the print mark to the groundwood paper;
a pattern-paper-setting stage in which the pattern paper is placed on the groundwood paper to which the print mark has been transferred, so that the print mark outline reference aperture in the pattern paper is aligned with the transferred print mark;
a second thick silicone-rubber-plate-setting stage in which a second thick silicone-rubber plate is placed on the print mark outline reference aperture in the pattern paper;
a stage in which an object to which a mark is to be transferred is placed on the pattern paper on the transfer platform so that the object is aligned with the frame of the outline reference plan view of the object; and
a stage for transferring the print-mark to the object, in which stage one mark is pulled out of the roll-shaped transfer film by using a pullout means of the continuous-transfer machine so that the pulled-out mark is pressed against the object on the transfer platform by the press part, so as to transfer the mark to the object.

3. The print-mark transfer system for roll-shaped transfer film according to claim 1, and wherein in the final stage for transferring the print-mark to the object, after the press part has pressed the print mark of the roll-shaped transfer film against the transfer film, the press part moves up accompanying the plastic base film, automatically separating the film from the mark that has been transferred to the object.

4. The print-mark transfer system for roll-shaped transfer film according to claim 1, and wherein the print mark is formed by accumulating multiple layers on top of each other on the plastic base film, and wherein the layers include a release layer, a protective layer, a design layer, a functional layer (covering layer, ink layer), a resin layer, and an adhesive layer, with the layers being formed such that:
the release layer is formed by uniform application of a parting agent that is made of organic material and that is removable after firing;
the protective layer is made of organic material and is removable after firing, so as to strengthen the design layer before the design layer is fired;
the design layer is formed by using printing techniques such as screen printing, offset printing, ink-jet printing, and color copying, so that designed marks can be of any shape;
the functional layer (covering layer, ink layer) is formed by screen printing using synthetic resins, including polyurethane resin, and an acrylic resin that is not damaged by washing, dry cleaning, friction, or elongation;
the resin layer is formed by screen printing using the same organic material as that of the protective layer, so as to increase the adhesion between the functional layer (covering layer, ink layer) and an adhesive layer; and
the adhesive layer, which is adhered to the object to which a mark is to be transferred, is formed by a process that includes the following steps: hot melt powder that has a particle size of about 50 μm-300 μm and that is formed of materials selected from high-polymer materials including urethane, nylon, polyester, and ethylene-vinyl acetate copolymer (EVA), with said material(s) being selected depending on the nature of the object to which a mark is to be transferred, is sprayed onto the just-formed and wet resin-layer, and is left to be dried so as to be fixed on the resin layer; the hot melt powder that remains without been fixed on the resin layer is removed; and the hot melt powder is heated so as to be fixed on the resin layer.

5. The print-mark transfer system for roll-shaped transfer film according to claim 2, and wherein in the final stage for transferring the print-mark to the object, after the press part has pressed the print mark of the roll-shaped transfer film against the transfer film, the press part moves up accompanying the plastic base film, automatically separating the film from the mark that has been transferred to the object.

6. The print-mark transfer system for roll-shaped transfer film according to claim 2, and wherein the print mark is formed by accumulating multiple layers on top of each other on the plastic base film, and wherein the layers include a release layer, a protective layer, a design layer, a functional layer (covering layer, ink layer), a resin layer, and an adhesive layer, with the layers being formed such that:
the release layer is formed by uniform application of a parting agent that is made of organic material and that is removable after firing;
the protective layer is made of organic material and is removable after firing, so as to strengthen the design layer before the design layer is fired;
the design layer is formed by using printing techniques such as screen printing, offset printing, ink-jet printing, and color copying, so that designed marks can be of any shape;
the functional layer (covering layer, ink layer) is formed by screen printing using synthetic resins, including polyurethane resin, and an acrylic resin that is not damaged by washing, dry cleaning, friction, or elongation;
the resin layer is formed by screen printing using the same organic material as that of the protective layer, so as to increase the adhesion between the functional layer (covering layer, ink layer) and an adhesive layer; and
the adhesive layer, which is adhered to the object to which a mark is to be transferred, is formed by a process that includes the following steps: hot melt powder that has a particle size of about 50 μm-300 μm and that is formed of materials selected from high-polymer materials including urethane, nylon, polyester, and ethylene-vinyl acetate copolymer (EVA), with said material(s) being selected depending on the nature of the object to which a mark is to be transferred, is sprayed onto the just-formed and wet resin-layer, and is left to be dried so as to be fixed on the resin layer; the hot melt powder that remains without been fixed on the resin layer is removed; and the hot melt powder is heated so as to be fixed on the resin layer.

7. The print-mark transfer system for roll-shaped transfer film according to claim 3, and wherein the print mark is formed by accumulating multiple layers on top of each other on the plastic base film, and wherein the layers include a release layer, a protective layer, a design layer, a functional layer (covering layer, ink layer), a resin layer, and an adhesive layer, with the layers being formed such that:
the release layer is formed by uniform application of a parting agent that is made of organic material and that is removable after firing;
the protective layer is made of organic material and is removable after firing, so as to strengthen the design layer before the design layer is fired;
the design layer is formed by using printing techniques such as screen printing, offset printing, ink-jet printing, and color copying, so that designed marks can be of any shape;
the functional layer (covering layer, ink layer) is formed by screen printing using synthetic resins, including polyurethane resin, and an acrylic resin that is not damaged by washing, dry cleaning, friction, or elongation;
the resin layer is formed by screen printing using the same organic material as that of the protective layer, so as to increase the adhesion between the functional layer (covering layer, ink layer) and an adhesive layer; and
the adhesive layer, which is adhered to the object to which a mark is to be transferred, is formed by a process that includes the following steps: hot melt powder that has a particle size of about 50 μm-300 μm and that is formed of materials selected from high-polymer materials including urethane, nylon, polyester, and ethylene-vinyl acetate copolymer (EVA), with said material(s) being selected depending on the nature of the object to which a mark is to be transferred, is sprayed onto the just-formed and wet resin-layer, and is left to be dried so as to be fixed on the resin layer; the hot melt powder that remains without been fixed on the resin layer is removed; and the hot melt powder is heated so as to be fixed on the resin layer.
